(19) United States
(12) Patent Application Publication
(10) Pub. No.: US 2017/0016596 A1
(43) Pub. Date: Jan. 19, 2017

(54) MULTI-SYNCHRONIZING FOCUSING APPARATUS FOR REFLECTOR SHADOWLESS LAMP

(71) Applicant: JW MEDICAL CORPORATION, Seoul (KR)

(72) Inventors: Joon Hyung Kim, Yongin-si, Gyeonggi-do (KR); Dong Soo Jeong, Incheon (KR); Keun Hwan Kim, Bucheon-si, Gyeonggi-do (KR); Soon Min Hong, Seongnam-si, Gyeonggi-do (KR)

(73) Assignee: JW BIOSCIENCE CORPORATION, Chungju-si, Chungcheongbuk-do (KR)

(21) Appl. No.: 15/300,728

(22) PCT Filed: Apr. 22, 2015
(86) PCT No.: PCT/KR2015/004019

§ 371 Date: Sep. 29, 2016

(30) Foreign Application Priority Data
May 15, 2014 (KR) 10-2014-0058558

(51) Int. Cl. F21V 14/04

(52) U.S. Cl. CPC F21V 14/04; F21V 23/0471

(57) ABSTRACT

The present invention relates to a focusing apparatus for a reflector shadowless lamp, and to a multi-synchronizing focusing apparatus for a reflector shadowless lamp, which synchronizes multiple focusings so as to implement various light field diameter sizes necessary for the shadowless lamp, thereby conveniently implementing light field diameter sizes necessary for various surgical environments.

### TECHNICAL FIELD

The present invention relates to a focusing apparatus for a reflector shadowless lamp, and to a multi-synchronizing focusing apparatus for a reflector shadowless lamp, which synchronizes multiple focusings so as to implement various light field diameter sizes necessary for the shadowless lamp, thereby conveniently implementing light field diameter sizes necessary for various surgical environments.

### BACKGROUND ART

As it is already known, a shadowless lamp serves to prevent shadows owing to operators such as a doctor or an assistant etc., who perform a surgery, from being generated on the affected part of the patient as well as uniformly illuminate the affected part thereof.

Generally, the conventional shadowless lamp includes a plurality of bulbs arranged on a surface of the lamp body. The lights emitted from each bulb illuminate the affected part in different angles respectively. Also, the shadow caused by the light emitted from one bulb is offset by the light emitted by the other bulb, so that it can prevent the generation of the shadow owing to the operators.

In these shadowless lamps, there are a lens type for preventing the spread of the light generated by the light source through the lens to be collected and a reflector type for collecting the light through one or more reflectors.

A “shadowless lamp” (Korea Patent Laying-Open gazette No. 2002-0035425, Patent Literature 1) as a technique related to the lens type includes a condenser lens for irradiating a light emitted from a light source in a parallel light flux and a circumferential direction, reflector for reflecting the light emitted through the lens in a predetermined direction, and an outer lens for refracting the light reflected from the reflector.

However, in the Patent Literature 1 described above, there is a problem in that the design of the outer lens is very complicated because the light passing through the lens should be refracted towards a certain point.

Further, in the shadowless lamp of the lens type, since it is impossible to control a light field, the distance between the shadowless lamp and the procedure position should be constant. Accordingly, there is a problem in that it is difficult to apply to a variety of operative environments.

In a “shadowless lamp using LED” (Korean patent registration No. 10-1259470, Patent Literature 2), a light source is constituted by a white LED and the like, so that it can improve the optical output and the quality of the light source.

In the configuration of Patent Literature 2, it solves the above problem by using a halogen lamp or a xenon lamp. However, since it is also impossible to control the light field, there is a problem in that it is difficult to apply to a variety of operative environments.

### CITATION LIST

### Patent Literature 1

Korean Patent Laying-open gazette No. 10-2002-0035425 (May 11, 2002)

### Patent Literature 2

Korean Patent Registration No. 10-1259470 (Apr. 24, 2013)

### DISCLOSURE

### Technical Problem

The present invention has been made in an effort to solve the problems of the conceptual description of the conventional art as described above, and an object of the present invention is to provide a multi-synchronizing focusing apparatus for a reflector shadowless lamp in that each individual light source unit including a lamp and a reflector is rotatable, they are interlocked with and rotated to each other by a link structure, and an auxiliary reflector capable of adjusting a distance of the lamp is formed on each light source unit, so that it can synchronizes multiple focusings, thereby enabling the adjustment of the focusing.

That is, the present invention is to provide a multi-synchronizing focusing apparatus for a reflector shadowless lamp capable of providing an illumination appropriate for various surgical environments through the focusing control.

### Technical solution

According to one aspect of the present invention so as to accomplish these objects, there is provided to a multi-synchronizing focusing apparatus for a reflector shadowless lamp, including: a fixed case (10) having a handle insertion hole (11) vertically formed at a center thereof and a plurality of lower link coupling units (12) protruded to an outside thereof; a handle (20) having one side inserted into the handle insertion hole (11) of the fixed case (10), the other side protruded upwards to the handle insertion hole (11), and a first screw thread (21) formed on an outer circumferential surface thereof; a moving case (30) having a second screw thread (31), which is screw-coupled to the first screw thread (21), formed at an inner circumferential surface thereof so as to move up and down according to a rotation of the handle 20 and a plurality of upper link coupling units (32) protruded to an outside thereof; a main reflector (40) having one side of a lower portion of an outer circumferential surface thereof linked to the lower link coupling units (12) and one side of a middle portion of an outer circumferential surface thereof linked to the upper link coupling units (32); a lamp (50) formed on a center of the main reflector (40); an auxiliary housing (60) connected to the main reflector (40); and an auxiliary reflector (70) installed in the auxiliary housing (60) and corresponded to a front of the lamp 50.

At this time, the auxiliary housing (60) is connected to the main reflector (40) to be movable up and down; and a moving unit (80) for moving the auxiliary housing (60) up and down having one side connected to the main reflector (40) and the other side connected to the auxiliary housing (60) is further formed.

Also, the multi-synchronizing focusing apparatus for the reflector shadowless lamp further includes: a potentiometer (90) for calculating the number of revolutions of the handle (20) formed at a front end of the other side of handle (20); and a control unit (100) for controlling the moving distance of the moving unit (80) in accordance with the number of revolutions of the potentiometer (90) and having one side electrically connected to the potentiometer (90) and other side electrically connected to the moving unit (80).

Moreover, a motor (22) is connected to the handle (20), so that the handle (20) is rotated by the motor (22) and the motor (22) is electrically connected to the control unit (100), so that it is operated by the control of the control unit (100).

Furthermore, the moving unit (80) includes an electric actuator; the auxiliary housing (60) comprises a base frame (61) having one side connected to the actuator and a plurality of support bars (62) connected to the base frame (61) and penetrated through the main reflector (40); and each front end of the support bars (62) is connected to the outer circumferential surface of the auxiliary reflector (70).

### Advantageous Effects

According to the present invention, each individual light source unit including the lamp and the reflector is rotatable, they are interlocked with and rotated to each other by the link structure, and the auxiliary reflector capable of adjusting the distance of the lamp is formed on each light source unit, so that it can synchronizes multiple focusings, thereby enabling the adjustment of the focusing.

That is, it can provide the multi-synchronizing focusing apparatus for the reflector shadowless lamp capable of providing the illumination appropriate for various surgical environments through the focusing control.

### BRIEF DESCRIPTION OF DRAWINGS

The above and other objects, features and advantages of the present invention will be more apparent from the following detailed description taken in conjunction with the accompanying drawings, in which:

FIG. 1 is an exploded sectional view illustrating a multi-synchronizing focusing apparatus for a reflector shadowless lamp according to the present invention;

FIG. 2 is a sectional view illustrating a multi-synchronizing focusing apparatus for a reflector shadowless lamp according to the present invention;

FIG. 3 is a sectional view illustrating a state in that a main reflector is rotated by moving a moving case upward by means of a rotation of a handle of FIG. 2;

FIG. 4 is a sectional view illustrating a state in that a distance between an auxiliary reflector and a lamp becomes narrow from a state of FIG. 3;

FIG. 5 is a block diagram illustrating an embodiment provided with a control unit in the present invention; and

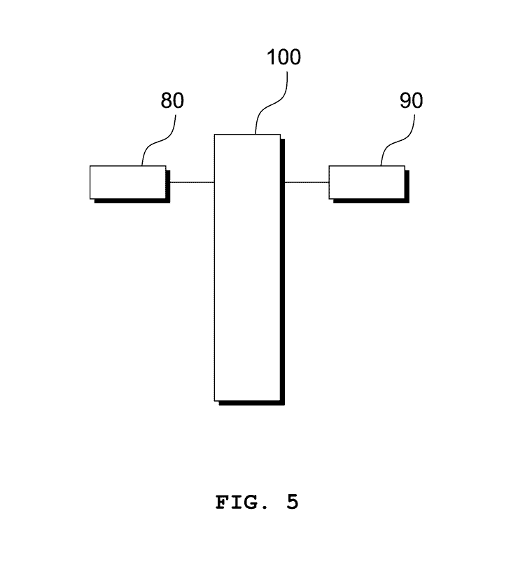

FIG. 6 is a conceptual diagram illustrating a change state of a light field in accordance with the present invention.

### REFERENCE SIGNS LIST

A: light field

10: fixed case

11: handle insertion hole

12: lower link coupling unit

20: Handle

21: first screw thread

22: motor

30: moving case

31: second screw thread

32: upper link coupling unit

40: main reflector

50: lamp

60: auxiliary housing

61: base frame

62: support bar

70: auxiliary reflector

80: moving unit

90: potentiometer

100: control unit

### BEST MODE

### Mode for Invention

Hereinafter, a multi-synchronizing focusing apparatus for a reflector shadowless lamp according to the present invention will be described in detail with reference to the accompanying drawings.

The multi-synchronizing focusing apparatus for the reflector shadowless lamp according to the present invention includes a fixed case (10), a handle (20), a moving case (30), a main reflector (40), a lamp (50), an auxiliary housing (60), and an auxiliary reflector (70).

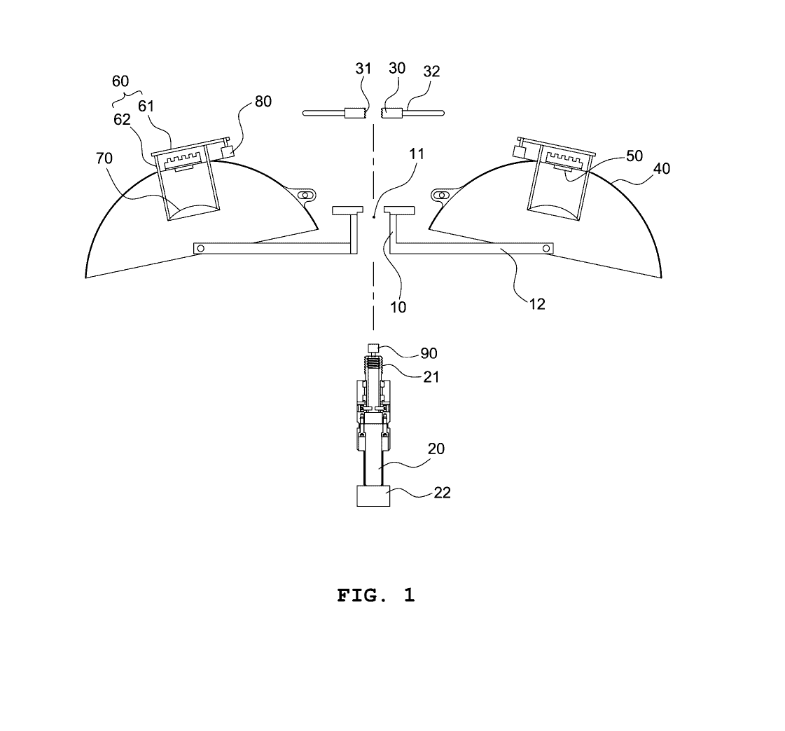

As shown in FIG. 1, the fixed case (10) includes a handle insertion hole (11) vertically formed at a center thereof and a plurality of lower link coupling units (12) protruded to an outside thereof.

At this time, as shown, where there are two lower link coupling units (12), a double synchronization becomes available.

The handle (20) includes one side of an upper portion thereof inserted into the handle insertion hole (11) of the fixed case (10).

In addition, the handle (20) includes an upper portion protruded upwards to the handle insertion hole (11) and a first screw thread (21) formed on an outer circumferential surface thereof as shown.

Preferably, the handle (20) is freely rotated and connected to the fixed case (10) in a state that it is inserted into the handle insertion hole (11).

To this end, it is preferred that bearings, which are not marked in drawings, are formed at an inner circumferential surface of the handle insertion hole (11). Also, it is preferred that a stopper, which are not marked in drawings, is formed at an inner circumferential surface of the handle insertion hole (11) and a protrusion, which is hung on the stopper, is formed at an outer circumferential surface of the handle (20) in order that the handle insertion hole (11) is not moved up and down.

That is, the handle 20 is not vertically moved in the fixed case (10) while being freely rotated to the fixed case.

In addition, a knob, which is not shown in drawings, can be formed on the handle 20 for manual operation of the handle 20. Also, a motor 22, which is described below, is connected thereto, so that it can be automatically rotated.

As shown, the moving case (30) includes a second screw thread (31), which is screw-coupled to the first screw thread (21), formed at an inner circumferential surface thereof so as to move up and down according to a rotation of the handle 20.

Also, the moving case (30) includes a plurality of upper link coupling units (32) protruded to an outside thereof.

At this time, the upper link coupling units (32) are formed at a position corresponding to the above-mentioned lower link coupling units (12).

The main reflector (40) forms a semi-spherical structure like the reflector of the general shadowless lamp and the inner circumferential surface thereof is made of a material that reflects the light emitted from the lamp 50.

That is, the inner circumferential surface of the main reflector 40 is a secondary reflecting plate.

The main reflector 40 includes one side of a lower portion of an outer circumferential surface thereof linked to the lower link coupling units (12) and one side of a middle portion of an outer circumferential surface thereof linked to the upper link coupling units (32).

That is, it forms a structure pin-linked to the lower link coupling units (12) and the upper link coupling units (32).

In this case, since the moving case (30) is moved up and down, the main reflector 40 is rotated in a clockwise direction or counterclockwise direction based on the points connected to the lower link coupling units (12) by means of the movement of the moving case (30) through the rotation of the handle (20) and the vertical movement of the moving case connected to the handle.

The lamp (50) is formed on a center of the main reflector (40). Preferably, it is a LED lamp.

The auxiliary housing (60) is connected to the main reflector (40) and configured to fix the auxiliary reflector (70).

The auxiliary reflector (70) is installed in the auxiliary housing (60) and corresponded to a front of the lamp 50. The light emitted from the lamp 50 is primarily reflected toward the inner circumferential surface of the main reflector (40) by means of the auxiliary reflector (70) and it is secondarily reflected on the inner circumferential surface of the main reflector (40), so that the light is irradiated toward the operating table.

By installing the auxiliary reflector (70), the light emitted from the lamp (50) can be more broadly irradiated through two reflections, so that it can reduce of the loss of the light source.

That is, in the present invention, it can reduce the loss of the light source through the auxiliary reflector (70). Also, the plurality of the main reflectors (40) is rotated through the movement of a moving case (30), so that the light intersects in the opposite directions, thereby minimizing the loss of the light source, increasing the quantity of light in the overlapped portions, and forming the light field of a predetermined size on the treatment area although the distance between the light source to the treatment location is changed.

In the above constructions, the auxiliary housing (60) can be configured to be fixed to the main reflector (40). However, more preferably, the auxiliary housing (60) is connected to the main reflector (40) to be movable up and down for the location movement of the auxiliary reflector (70).

Accordingly, the position of the focus can be vertically controlled through the vertical movement of the auxiliary reflector (70), so that it can be positively used against various distance environments between the shadowless lamp and the treatment location. To this end, as shown, the multi-synchronizing focusing apparatus for a reflector shadowless lamp according to the present invention further includes a moving unit (80) for moving the auxiliary housing (60) up and down having one side connected to the main reflector (40) and the other side connected to the auxiliary housing (60). Referring to the drawing, the moving unit (80) includes an electric actuator and the auxiliary housing (60) includes a base frame (61) having one side connected to the actuator and a plurality of support bars 62 connected to the base frame (61) and penetrated through the main reflector (40). Also, it can be seen that each front end of the support bars (62) is connected to the outer circumferential surface of the auxiliary reflector (70).

In other words, the base frame (61) and the support bar (62) are moved up and down in accordance with the operation of the actuator, so that the auxiliary reflector (70), which is connected to the support bars (62), is moved up and down.

Accordingly, the reflection position of the light irradiated from the lamp (50) is changed, so that the range and focus position of the light reflected from the inner circumferential surface are varied.

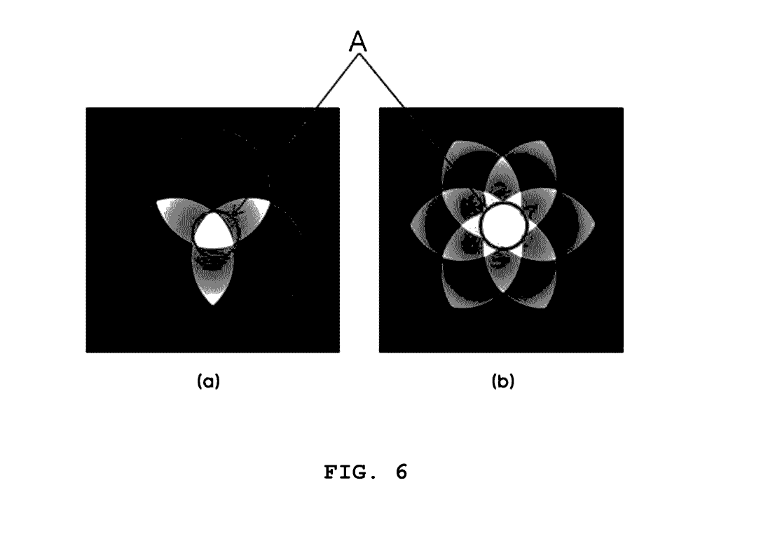

In particular, as shown in FIGS. 6(a) and (b), if the number of the main reflectors (40) linked to each other is increased, since the shape of the light field (A) is closed to a circle, it can be seen that the operation such as a surgery etc. is easier and the intensity illuminate is increased.

In addition, by utilizing the change of rotation angle of the main reflector (40) in accordance with the operation of the handle (20) and the change of position of the auxiliary reflector (70) in accordance with the operation of moving unit (80) at the same time, although the distance between the shadowless lamp and the operating table or the treatment location is changed, it can have the light field of a predetermined diameter through the control thereof.

At this time, the operation of the handle (20) and the operation of the moving unit (80) can be manually conducted. However, they can be also automatically adjusted.

More concretely, as shown, the multi-synchronizing focusing apparatus for a reflector shadowless lamp according to the present invention further includes a potentiometer (90) for calculating the number of revolutions of the handle (20) formed at a front end of the other side of handle (20) and a control unit (100) for controlling the moving distance of the moving unit (80) in accordance with the number of revolutions of the potentiometer (90).

In this configuration, it calculates the number of revolutions of the potentiometer (90) according to the operation of the handle (20) by means of the user then, the moving unit (80) automatically moves the auxiliary housing (60), so that the distance between the lamp (50) and the auxiliary reflector (70) can be changed.

Here, the handle (20) can be manually operated by the user. Also, as shown, the motor (22) is connected to the handle (20), so that the handle (20) can be rotated by the motor (22). At this time, the motor (22) is electrically connected to the control unit (100) and operated by the control of the control unit (100).

In addition, by utilizing a distance sensor such as a laser sensor for measuring the distance between the shadowless lamp and the operating table or the treatment location, the motor (22) and the actuator are automatically operated according to the measured distance. Or, if the user inputs the distance through a button etc., the motor (22) and the actuator can be automatically operated.

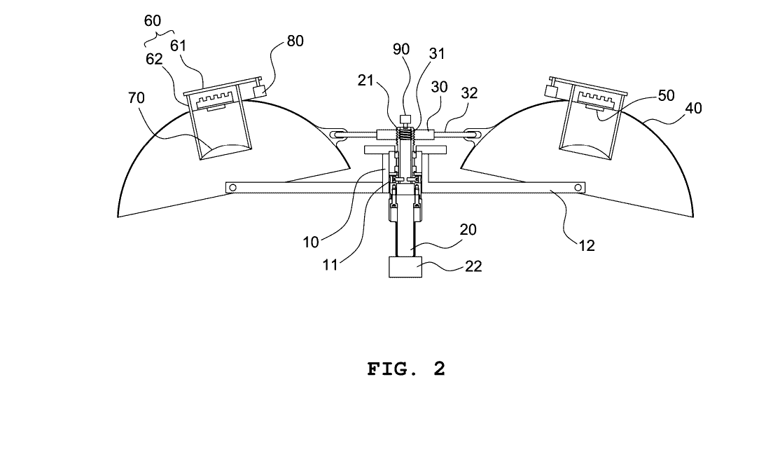

FIG. 2 through FIG. 4 illustrate the operation examples of a multi-synchronizing focusing apparatus for a reflector shadowless lamp according to the present invention.

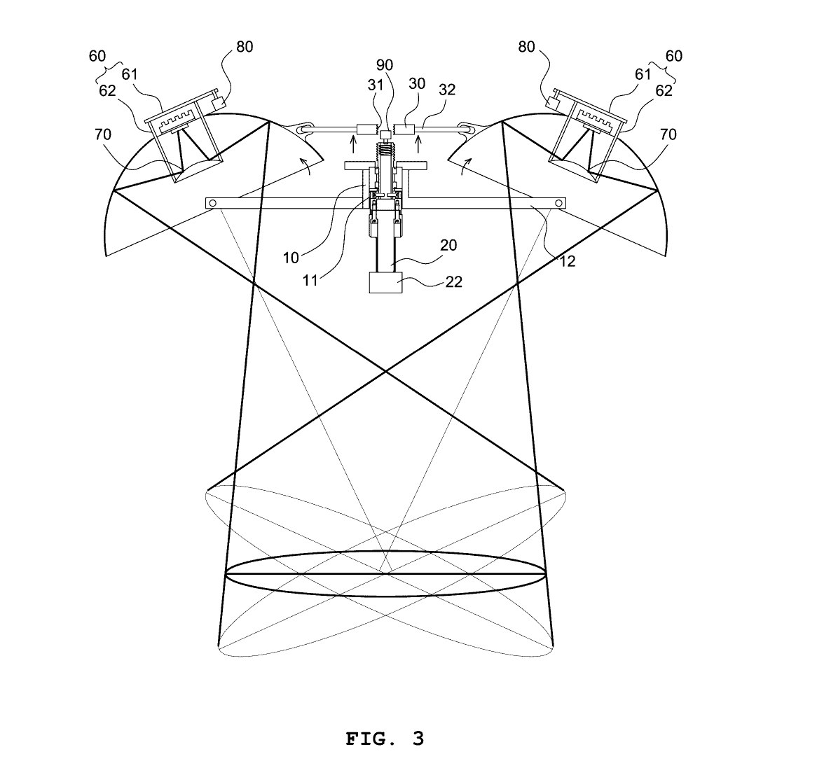

FIG. 2 illustrates a basic installation state thereof and FIG. 3 illustrates an operation state of the handle (20) of FIG. 2.

Concretely, in a state of FIG. 2, if the handle (20) is rotated and the moving case 30 is moved upward by means of the screw coupling thereof, both main reflectors (40) are rotated in the opposite directions to each other based on the lower link coupling units (12).

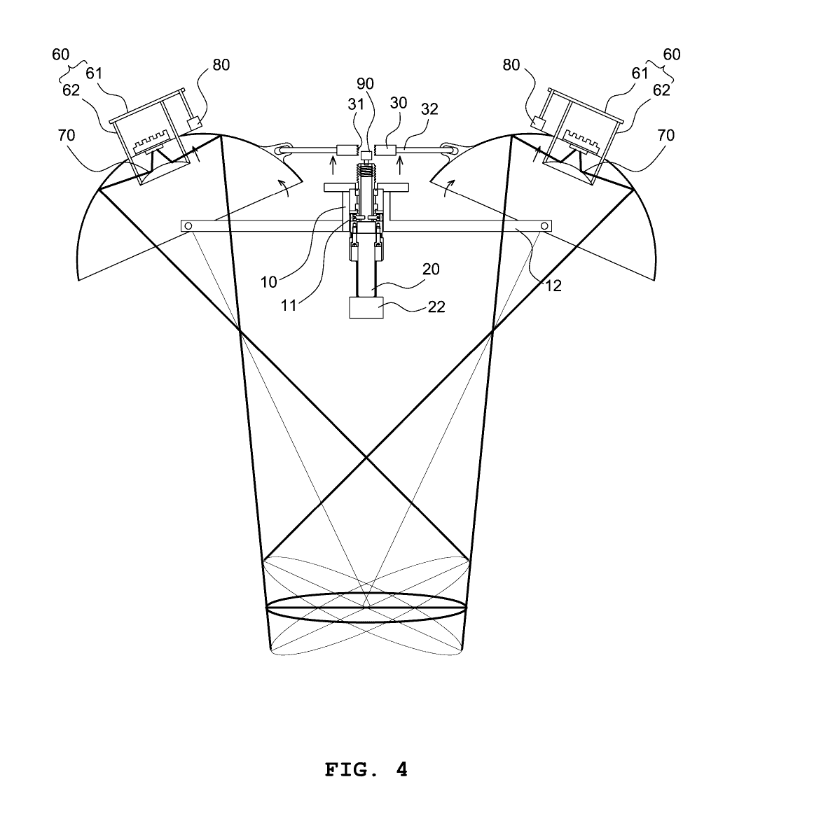

The portions indicated by a thick solid line in the drawings show a state in that the light emitted from the lamp (50) is reflected through the inner circumferential surface of the main reflector (40) and the auxiliary reflector (70). Since two main reflectors (40) are rotated in the opposite directions to each other based on FIG. 2, it can be seen that the lights reflected through the inner circumferential surfaces of each main reflector (40) are overlapped each other and the overlapped position can be changed according to the angle of rotation thereof. FIG. 4 illustrates a state in that the auxiliary reflector (70) is moved by the operation of the moving unit (80) in the state of FIG. 3.

Since the auxiliary reflector 70 is moved, the reaching area of the firstly reflected light is changed on the inner circumferential surface of the main reflector 40, so that the overlapped position of the reflected lights is varied as shown in FIG. 3.

In the end, by utilizing the change of rotation angle of the main reflector (40) in accordance with the operation of the handle (20) and the change of position of the auxiliary reflector (70) in accordance with the operation of moving unit (80) at the same time, although the distance between the shadowless lamp and the operating table or the treatment location is varied, it can have the light field of a predetermined diameter through the control thereof.

### INDUSTRIAL APPLICABILITY

The present invention is applicable to various medical procedures and surgeries performed under the lamp, and can be applied in a variety of industrial and residential lighting fixtures that require the lighting with uniform brightness.

What is claimed is:

1. A multi-synchronizing focusing apparatus for a reflector shadowless lamp, comprising:
a fixed case (10) having a handle insertion hole (11) vertically formed at a center thereof and a plurality of lower link coupling units (12) protruded to an outside thereof;
a handle (20) having one side inserted into the handle insertion hole (11) of the fixed case (10), the other side protruded upwards to the handle insertion hole (11), and a first screw thread (21) formed on an outer circumferential surface thereof;
a moving case (30) having a second screw thread (31), which is screw-coupled to the first screw thread (21), formed at an inner circumferential surface thereof so as to move up and down according to a rotation of the handle 20 and a plurality of upper link coupling units (32) protruded to an outside thereof;
a main reflector (40) having one side of a lower portion of an outer circumferential surface thereof linked to the lower link coupling units (12) and one side of a middle portion of an outer circumferential surface thereof linked to the upper link coupling units (32);
a lamp (50) formed on a center of the main reflector (40);
an auxiliary housing (60) connected to the main reflector (40); and
an auxiliary reflector (70) installed in the auxiliary housing (60) and corresponded to a front of the lamp (50).

2. The multi-synchronizing focusing apparatus for the reflector shadowless lamp as claimed in claim 1, wherein the auxiliary housing (60) is connected to the main reflector (40) to be movable up and down; and
a moving unit (80) for moving the auxiliary housing (60) up and down having one side connected to the main reflector (40) and the other side connected to the auxiliary housing (60) is further formed.

3. The multi-synchronizing focusing apparatus for the reflector shadowless lamp as claimed in claim 2, further comprising:
a potentiometer (90) for calculating the number of revolutions of the handle (20) formed at a front end of the other side of handle (20); and
a control unit (100) for controlling the moving distance of the moving unit (80) in accordance with the number of revolutions of the potentiometer (90) and having one side electrically connected to the potentiometer (90) and other side electrically connected to the moving unit (80).

4. The multi-synchronizing focusing apparatus for the reflector shadowless lamp as claimed in claim 3, wherein a motor (22) is connected to the handle (20), so that the handle (20) is rotated by the motor (22) and the motor (22) is electrically connected to the control unit (100), so that it is operated by the control of the control unit (100).

5. The multi-synchronizing focusing apparatus for the reflector shadowless lamp as claimed in claim 4, wherein the moving unit (80) comprises an electric actuator; the auxiliary housing (60) comprises a base frame (61) having one side connected to the actuator and a plurality of support bars (62) connected to the base frame (61) and penetrated through the main reflector (40); and each front end of the support bars (62) is connected to the outer circumferential surface of the auxiliary reflector (70).
